(19) United States
(12) Patent Application Publication
(10) Pub. No.: US 2012/0216717 A1
(43) Pub. Date: Aug. 30, 2012

(54) TUNGSTEN CONTAINING INORGANIC PARTICLES WITH IMPROVED PHOTOSTABILITY

(75) Inventors: John Davis Bolt, Kingston, TN (US); Eugene Michael McCarron, III, Chadds Ford, PA (US); Charles David Musick, Waverly, TN (US)

(73) Assignee: E. I. DUPONT DE NEMOURS AND COMPANY, Wilmington, DE (US)

(21) Appl. No.: 13/505,466

(22) PCT Filed: Nov. 9, 2010
(86) PCT No.: PCT/US10/55913

§ 371 Date: May 2, 2012

Related U.S. Application Data
(60) Provisional application No. 61/384,856, filed on Sep. 21, 2010.

(51) Int. Cl. C08K 3/22

(52) U.S. Cl. 106/439; 106/479

(57) ABSTRACT

This disclosure relates to inorganic particles, typically inorganic metal oxide or mixed metal oxide particles, and more typically titanium dioxide (TiO₂) particles, comprising at least about 0.002% of tungsten, based on the total weight of the inorganic particles, wherein inorganic particles have a photostability ratio (PSR) of at least about 2, as measured by the Ag⁺ photoreduction rate, and color as depicted by an L* of at least about 97.0, and b* of less than about 4. These titanium dioxide particles comprising tungsten may further comprise alumina.

### BACKGROUND OF THE DISCLOSURE

1. Field of the Disclosure

The present disclosure relates to a process for preparing inorganic particles, typically titanium dioxide, and in particular to the preparation of inorganic particles, typically titanium dioxide comprising tungsten and alumina.

2. Background of the Disclosure

Titanium dioxide pigments are prepared using either the chloride process or the sulfate process. In the preparation of titanium dioxide pigments by the vapor phase chloride process, titanium tetrachloride, TiCl₄, is reacted with an oxygen containing gas at temperatures ranging from about 900° C. to about 1600° C., the resulting hot gaseous suspension of TiO₂ particles and free chlorine is discharged from the reactor and must be quickly cooled below about 600° C., for example, by passing it through a conduit, i.e., flue, where growth of the titanium dioxide pigment particles and agglomeration of said particles takes place.

It is known to add various substances, such as silicon compounds and aluminum compounds, to the reactants in order to improve the pigmentary properties of the final product. Aluminum trichloride added during the process has been found to increase rutile in the final product, and silicon tetrachloride that becomes silica in the final product has been found to improve carbon black undertone (CBU), particle size and pigment abrasion. It is useful to be able to add elements to the titanium dioxide particles. However, the process and materials to be added to improve properties of the titanium dioxide particles may be hazardous.

One method of adding elements to the surface of a particle is by impregnation with a solution containing the element. This is difficult to do with pyrogenically prepared metal oxide particles since the properties of the pyrogenically produced metal oxides change upon contact with a liquid medium.

A need exists for a low cost approach for adding elements to pyrogenically prepared metal oxide particles, particularly titanium dioxide particles without changing the color of the product.

### SUMMARY OF THE DISCLOSURE

In a first aspect, the disclosure provides inorganic particles, typically inorganic metal oxide or mixed metal oxide particles, more typically titanium dioxide (TiO₂) particles, comprising at least about 0.002% of tungsten, more typically at least about 0.004% of tungsten and still more typically at least about 0.01% of tungsten, and most typically at least about 0.05% of tungsten, based on the total weight of the inorganic particles, typically inorganic metal oxide or mixed metal oxide particles, more typically titanium dioxide particles, wherein the inorganic particles, typically inorganic metal oxide or mixed metal oxide particles, more typically titanium dioxide particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, typically inorganic metal oxide or mixed metal oxide particles, more typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles, typically inorganic metal oxide or mixed metal oxide particles, more typically titanium dioxide particles.

Photostability Ratio (PSR) is defined as the Ag⁺ photoreduction rate of the TiO₂ particle without tungsten divided by the Ag⁺ photoreduction rate of the TiO₂ particle with tungsten.

In a second aspect, the disclosure provides a process for producing titanium dioxide particles comprising:

a) mixing of chlorides of titanium, tungsten or mixtures thereof; wherein at least one of the chlorides is in the vapor phase;

(b) oxidizing the chlorides of titanium, tungsten or mixtures thereof; and

(d) forming titanium dioxide particles comprising at least about 0.002% of tungsten, more typically at least about 0.004% of tungsten and still more typically at least about 0.01% of tungsten, and most typically at least about 0.05% of tungsten, based on the total weight of the titanium dioxide particles, wherein the titanium dioxide particles have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the titanium dioxide particles comprising tungsten further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the titanium dioxide particles.

### BRIEF DESCRIPTION OF THE DRAWING

FIG. 1 is a schematic illustration showing the process for preparing titanium dioxide (TiO₂).

### DETAILED DESCRIPTION OF THE DISCLOSURE

This disclosure relates to inorganic particles, typically inorganic metal oxide or mixed metal oxide particles, more typically titanium dioxide particles, wherein the inorganic particles, typically inorganic metal oxide or mixed metal oxide particles, more typically titanium dioxide particles comprise at least about 0.002% of tungsten, more typically at least about 0.004% of tungsten and still more typically at least about 0.01% of tungsten, and most typically at least about 0.05% of tungsten, based on the total weight of the inorganic particles, typically inorganic metal oxide or mixed metal oxide particles, more typically titanium dioxide particles, wherein the inorganic particles, typically inorganic metal oxide or mixed metal oxide particles, more typically titanium dioxide particles have a photostability ratio (PSR) of at least about 2, more typically at least about 4, and still more typically at least about 10, as measured by the Ag⁺ photoreduction rate, and color as depicted by L*a*b*, with L* of at least about 97.0, more typically at least about 98, and most typically at least about 99.0, and b* of less than about 4, and more typically less than about 3. Typically the inorganic particles, typically inorganic metal oxide or mixed metal oxide particles, more typically titanium dioxide particles comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles, typically inorganic metal oxide or mixed metal oxide particles, more typically titanium dioxide particles. Typically the alumina is co-ox alumina applied as described in U.S. Pat. No. 2,559,638.

This disclosure also relates to a process for preparing a treated inorganic particle, typically a titanium dioxide particle, to form a particle having improved photostability without any color change associated with the treatment and that is capable of being dispersed into a coating composition, a polymer melt for preparing a plastic part or a laminate. The treated particle may be present in the amount of about 10 to 30 weight percent in coating compositions, 0.01 to 20 weight % in plastics final products.

### Treated Particle:

It is contemplated that any inorganic particle, and in particular inorganic particles that are photoactive, will benefit from the treatment of this disclosure. By inorganic particle it is meant an inorganic particulate material that becomes dispersed throughout a final product such as a polymer melt or coating or laminate composition and imparts color and opacity to it. Some examples of inorganic particles include but are not limited to ZnO, TiO₂, or SrTiO₃.

In particular, titanium dioxide is an especially useful particle in the processes and products of this disclosure. Titanium dioxide (TiO₂) particles useful in the present disclosure may be in the rutile or anatase crystalline form. They are commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The particle may be a pigment or nanoparticle.

By “pigment” it is meant that the titanium dioxide particles have an average size of less than 1 micron. Typically, the particles have an average size of from about 0.020 to about 0.95 microns, more typically, about 0.050 to about 0.75 microns and most typically about 0.075 to about 0.50 microns. By “nanoparticle” it is meant that the primary titanium dioxide particles typically have an average particle size diameter of less than about 100 nanometers (nm) as determined by dynamic light scattering that measures the particle size distribution of particles in liquid suspension. The particles are typically agglomerates that may range from about 3 nm to about 6000 nm.

The titanium dioxide particle can be substantially pure titanium dioxide or can contain other metal oxides, such as alumina. Other metal oxides may become incorporated into the particles, for example, by co-oxidizing, post-oxidizing or co-precipitating titanium compounds with other metal compounds or precipitating other metal compounds on to the surface of the titanium dioxide particles. These are typically hydrous metal oxides. If co-oxidized, post-oxidized, precipitated or co-precipitated the amount of the metal oxide is about 0.06 to about 5%, more typically about 0.2% to about 4%, still more typically about 0.5% to about 3%, and most typically about 0.8% to about 2%, based on the total weight of the titanium dioxide particles. Tungsten may also be introduced into the particle using co-oxidizing, or post-oxidizing. If co-oxidized or post-oxidized at least about 0.002 wt. % of the tungsten, more typically, at least about 0.004 wt. %, still more typically at least about 0.01 wt. % tungsten, and most typically at least about 0.05 wt. % may be present, based on the total particle weight.

### Process for Preparing Treated Titanium Dioxide Particles

The process for producing titanium dioxide particle comprises:

a) mixing of chlorides of, titanium, tungsten or mixtures thereof; wherein at least one of the chlorides is in the vapor phase;

(b) oxidizing the chlorides of, titanium, tungsten or mixtures thereof; and

(d) forming titanium dioxide (TiO₂) particles comprising at least about 0.002% of tungsten, more typically at least about 0.004% of tungsten and still more typically at least about 0.01% of tungsten, and most typically at least about 0.05% of tungsten, based on the total weight of the titanium dioxide particles, wherein the titanium dioxide particles have a photostability ratio (PSR) of at least 2, more typically at least 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the titanium dioxide particles comprising tungsten further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the titanium dioxide particles.

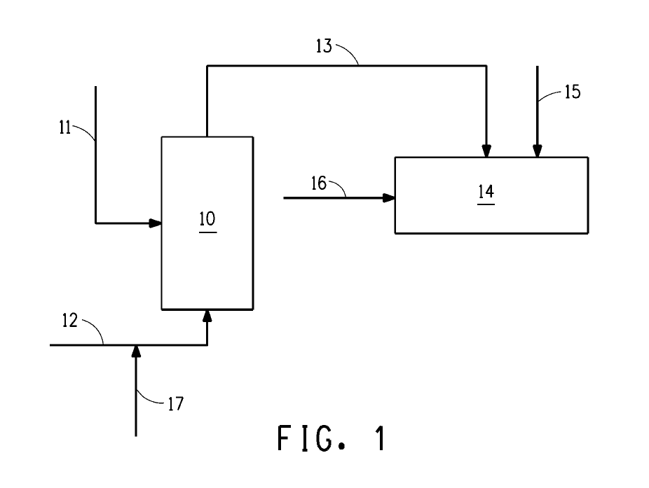

Methods known to one skilled in the art may be used to add tungsten to the titanium dioxide particles. In one specific embodiment, tungsten may be added to the titanium dioxide particle from an alloy comprising tungsten. As shown in FIG. 1, the alloy 11 and chlorine 12 are added to the generator 10. This reaction can occur in fluidized beds, spouting beds, packed beds, or plug flow reactors. The inert generator bed may comprise materials such as silica sand, glass beads, ceramic beads, TiO₂ particles, or other inert mineral sands. The alloy comprising aluminum, titanium or mixtures thereof and tungsten, 11, reacts in the generator 10 according to the following equations:

2Al+3 Cl₂→2AlCl₃+heat

Ti+2 Cl₂→TiCl₄+heat

W+3 Cl₂→WCl₆+heat

Al₁₂W+21 Cl₂→12AlCl₃+WCl₆+heat

The heat of reaction from the chlorination of the aluminum or titanium metal helps provide sufficient heat to drive the kinetics of the reaction between chlorine and one or more of the other elements.

Titanium tetrachloride 17 may be present during this reaction to absorb the heat of reaction. The chlorides formed in-situ comprise chlorides of the tungsten and chlorides of aluminum such as aluminum trichloride, chlorides of titanium such as titanium tetrachloride or mixtures thereof. The temperature of the reaction of chlorine with the alloy should be below the melting point of the alloy but sufficiently high enough for the rate of reaction with chlorine to provide the required amount of chlorides to be mixed with the TiCl₄.

Typical amounts of chlorine used in step (a) are about 0.4% to about 20%, more typically about 2% to about 5%, by weight, based on the total amount of all reactants. Typical amounts of titanium tetrachloride are about 75% to about 99.5% added in step (a) and (b), and more typically about 93% to about 98%, by weight, based on the total amount of all reactants.

The reaction of chlorine with the alloy occurs at temperature of above 190° C., more typically at temperature of about 250° C. to about 650° C., and most typically at temperatures of about 300° C. to about 500° C. In one specific embodiment where the metal is Ti the reaction occurs at temperature of above 50° C. (bp of TiCl₄=136° C.), more typically at temperature of about 200° C. to about 1000° C., and most typically at temperatures of about 300° C. to about 500° C.

The chlorides formed in the in-situ step 13 flows into an oxidation reactor 14 and titanium tetrachloride 15 is then added to the chlorides, such that titanium tetrachloride is present in a major amount. Vapor phase oxidation of the chlorides from step (a) and titanium tetrachloride is by a process similar to that disclosed, for example, in U.S. Pat. Nos. 2,488,439, 2,488,440, 2,559,638, 2,833,627, 3,208,866, 3,505,091, and 7,476,378. The reaction may occur in the presence of neucleating salts such as potassium chloride, rubidium chloride, or cesium chloride.

Such reaction usually takes place in a pipe or conduit, wherein oxygen 16, titanium tetrachloride 15 and the in-situ formed chlorides comprising chlorides of tungsten and chlorides of aluminum such as aluminum trichloride, chlorides of titanium such as titanium tetrachloride or mixtures thereof 13 are introduced at a suitable temperature and pressure for production of the treated titanium dioxide. In such a reaction, a flame is generally produced.

Downstream from the flame, the treated titanium dioxide produced is fed through an additional length of conduit wherein cooling takes place. For the purposes herein, such conduit will be referred to as the flue. The flue should be as long as necessary to accomplish the desired cooling. Typically, the flue is water cooled and can be about 50 feet (15.24 m) to about 3000 feet (914.4 m), typically about 100 feet (30.48 m) to about 1500 feet (457.2 m), and most typically about 200 feet (60.96 m) to 1200 feet (365.76 m) long.

### Applications

The treated inorganic particles, typically inorganic metal oxide or mixed metal oxide particles, more typically titanium dioxide may be used in coating compositions such as paints, plastic parts such as shaped articles or films, or paper laminates. The paper laminates of this disclosure are useful as flooring, furniture, countertops, artificial wood surface, and artificial stone surface.

The following Examples illustrate the present disclosure. All parts, percentages and proportions are by weight unless otherwise indicated.

### EXAMPLES

Photostability ratio (PSR) is the rate of photoreduction of Ag+ by TiO₂ particles without tungsten (control samples) divided by the rate of photoreduction of Ag+ by the otherwise same TiO₂ particles comprising tungsten. The rate of photoreduction of Ag+ can be determined by various methods. A convenient method was to suspend the TiO₂ particles in 0.1 M AgNO₃ aqueous solution at a fixed ratio of TiO₂ to solution, typically 1:1 by weight. The suspended particles were exposed to UV light at about 0.2 mW./cm² intensity. The reflectance of visible light by the suspension of TiO₂ particles was monitored versus time. The reflectance decreased from the initial value to smaller values as silver metal was formed by the photoreduction reaction, Ag⁺->Ag^{O}. The rate of reflectance decrease versus time was measured from the initial reflectance (100% visible reflectance with no UV light exposure) to a reflectance of 90% after UV exposure; that rate was defined as the rate of Ag⁺ photoreduction.

Color as measured on the CIE 1976 color scale, L*, a*, and b*, was measured on pressed pellets of dry TiO₂ powder.

### Comparative Example 1

Titanium dioxide made by the chloride process comprising 1.23% alumina by weight and having an L*a*b* color index of (99.98, 0.60, 2.13) and a rate of Ag⁺ photoreduction of 0.0528 sec⁻¹ was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (99.15, −0.45, 2.17) and a rate of Ag⁺ photoreduction of 0.1993 sec⁻¹.

### Comparative Example 2

Titanium dioxide made by the chloride process comprising 0.06% alumina by weight and having an L*a*b* color index of (99.43, −0.58, 1.36) and a photoactivity rate of 0.3322 was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (97.71, −0.03, 1.89) and a photoactivity rate of 0.2229 sec⁻¹.

### Example 3

Titanium dioxide similar to that described in Comparative Example 1 was well mixed with various amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios (PSR) as given in the following table:

| W (wt. %) | L* | a* | b* | PSR |
|---|---|---|---|---|
| 0.0 | 99.15 | −0.45 | 2.17 | 1.0 |
| 0.34 | 99.00 | −0.71 | 2.72 | 3.0 |
| 1.72 | 98.56 | −0.82 | 3.17 | 10.4 |
| 3.44 | 98.41 | −0.90 | 3.11 | 211.4 |

The increased incorporation of W clearly enhanced photostability up to roughly a factor of 200 while the color was only minimally affected.

### Example 4

Titanium dioxide similar to that described in Comparative Example 1 was impregnated via incipient wetness with various amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios as given in the following table:

| W (wt. %) | L* | a* | b* | PSR |
|---|---|---|---|---|
| 0.0 | 98.16 | 0.02 | 2.09 | 1.0 |
| 0.34 | 97.97 | −0.02 | 2.53 | 2.2 |
| 1.72 | 97.52 | −0.15 | 2.79 | 10.0 |
| 3.44 | 97.41 | −0.53 | 3.34 | 67.4 |

The increased incorporation of W clearly enhanced photostability up to roughly a factor of 67 while the color index was only minimally affected.

### Example 5

Titanium dioxide similar to that described in Comparative Example 2 was well mixed with amounts of ammonium tungstate, (NH₄)₁₀W₁₂O₄₁.5H₂O, to give samples having the W contents listed below. These samples were fired as described in Comparative Example 1. After firing the samples had L*a*b* color and photostability ratios as given in the following table:

| W (wt. %) | W | L* | a* | b* | PSR |
|---|---|---|---|---|---|
| 0.0 | 0.0 | 97.71 | −0.03 | 1.89 | 1.0 |
| 0.34 | 1x | 97.73 | −0.21 | 2.19 | 4.3 |
| 1.72 | 5x | 97.18 | −0.56 | 1.94 | 139.0 |
| 3.44 | 10x | 97.03 | −0.83 | 2.45 | 113.8 |

The increased incorporation of W clearly enhanced photostability up to roughly a factor of 140 while the color index was only minimally affected.

### Comparative Example 6

Titanium dioxide similar to that described in Comparative Example 1 was well mixed with various amounts of ammonium molybdate, (NH₄)₆Mo₇O₂₄.4H₂O, to give samples having the Mo contents listed below. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 98.76 | −0.37 | 2.48 | 1 |
| 0.18 | 94.08 | −3.45 | 17.96 | 314.8 |
| 0.91 | 93.77 | −4.47 | 30.45 | no rate |
| 1.83 | 91.89 | −5.27 | 35.82 | no rate |

The increased incorporation of Mo clearly enhanced photostability to the point where, at the higher Mo concentrations, the photostability ratio could not be determined. However, the material took on a decidedly yellow coloration clearly compromising its use as a white pigment.

### Comparative Example 7

Titanium dioxide similar to that described in Comparative Example 1 was impregnated via incipient wetness with various amounts of ammonium molybdate, (NH₄)₆Mo₇O₂₄.4H₂O, to give samples having Mo to Al atomic ratios of 0.1, 0.5, and 1.0 versus 0.0 for the undoped control. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 97.79 | −0.19 | 2.57 | 1.0 |
| 0.18 | 92.62 | −3.61 | 24.15 | 862.3 |
| 0.91 | 92.66 | −4.21 | 31.63 | 1188.0 |
| 1.83 | 90.74 | −4.92 | 37.94 | no rate |

The incorporation of Mo clearly enhanced photostability to the point where, at the highest Mo concentration, the photostability ratio could not be determined. However, the material took on a decidedly yellow coloration clearly compromising its use as a white pigment.

What is claimed is:

1. An Inorganic particle comprising at least about 0.002% of tungsten, based on the total weight of the inorganic particles, wherein the inorganic particles have a photostability ratio (PSR) of at least about 2, as measured by the Ag⁺ photoreduction rate, and color as depicted by an L* of at least about 97.0, and b* of less than about 4.

2. The inorganic particle of claim 1 wherein the inorganic particles are inorganic metal oxide or mixed metal oxide particles.

3. The inorganic particle of claim 2 wherein the inorganic metal oxide particles are titanium dioxide particles.

4. The inorganic particle of claim 3 comprising at least about 0.004% of tungsten.

5. The inorganic particle of claim 4 comprising at least about 0.01% of tungsten.

6. The inorganic particle of claim 5 comprising at least about 0.05% of tungsten,

7. The inorganic particle of claim 3 wherein the PSR is at least about 4.

8. The inorganic particle of claim 3 wherein the PSR is at least about 10

9. The inorganic particle of claim 3 wherein the L* is at least about 98.

10. The inorganic particle of claim 3 wherein the b* is less than about 3.

11. The inorganic particle of claim 3 further comprising alumina in the amount of about 0.06 to about 5% of alumina, based on the total weight of the Inorganic particles.

12. The inorganic particle of claim 11 further comprising alumina in the amount of about 0.2% to about 4% of alumina, based on the total weight of the Inorganic particles.

13. The inorganic particle of claim 12 further comprising alumina in the amount of about 0.5% to about 3% of alumina, based on the total weight of the Inorganic particles.

14. The inorganic particle of claim 13 further comprising alumina in the amount of about 0.8% to about 2%, based on the total weight of the Inorganic particles.

15. A process for producing titanium dioxide particles comprising:
a) mixing of chlorides of, titanium, tungsten or mixtures thereof; wherein at least one of the chlorides is in the vapor phase;
(b) oxidizing the chlorides of, titanium, tungsten or mixtures thereof; and
(c) forming titanium dioxide (TiO₂) particles comprising at least about 0.002% of tungsten, based on the total weight of the titanium dioxide particles, wherein the titanium dioxide particles have a photostability ratio (PSR) of at least 2, as measured by the Ag⁺ photoreduction rate, and color as depicted by an L* of at least about 97.0, and b* of less than about 4.

16. The process of claim 15 wherein the titanium dioxide particles comprise at least about 0.004% of tungsten.

17. The process of claim 16 wherein the titanium dioxide particles comprise at least about 0.01% of tungsten.

18. The process of claim 17 wherein the titanium dioxide particles comprise at least about 0.05% of tungsten.

19. The process of claim 15 wherein the titanium dioxide particles have a PSR of at least about 4.

20. The process of claim 15 wherein the titanium dioxide particles have an L* of at least about 98.

21. The process of claim 15 wherein the titanium dioxide particles have a b* of less than about 3.

22. The process of claim 15 wherein the titanium dioxide particles further comprise alumina in the amount of about 0.06 to about 5% of alumina, based on the total weight of the titanium dioxide particles.
